(19) United States
(12) Patent Application Publication
(10) Pub. No.: US 2006/0224822 A1
(43) Pub. Date: Oct. 5, 2006

(54) System and method for tagging and filtering electronic data

(76) Inventors: Scott A. Blomquist, Colorado Springs, CO (US); Robert G. Ward, Colorado Springs, CO (US)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/084,519

(22) Filed: Mar. 18, 2005

(51) Int. Cl. G06F 12/00; G06F 13/00; G06F 13/28

(52) U.S. Cl. 711/108

(57) ABSTRACT

A system and method for analyzing incoming traffic from a computer network, for example, an Asynchronous Transfer Mode (ATM) network. The system and method can identify and tag data prior to filtering according to identifying information contained in the data. A look-up table implemented, for example, in a Content Addressable Memory (CAM), can be used to map tags to the identifying information, and to provide the tag based on the presence of the identifying information in the data.

### BACKGROUND OF THE INVENTION

The speed that a network packet can traverse a network is in part limited by determinations that are usually made with respect to the packet at switching points, for example, whether to discard or retain the packet for further processing. Packets containing different protocols and arriving from multiple ports using thousands of port and circuit identifiers can be processed by a single system, for example, a switch. Such systems currently rely on pattern-based hardware filtering to sort packets into groups for further processing. These systems can contain “pattern matchers” that can be used to compare multiple specific byte values at fixed offsets in the packets and group the packets accordingly. Each byte value in the pattern matcher can be configured to match one or more values. The results of multiple pattern matchers can be chained together to make a final decision as to whether to, for example, retain or discard an incoming packet. This method has the following disadvantages: (1) the number of pattern matchers is limited because of space and timing constraints, and (2) configuring filtering for values that span multiple byte values results in “filter expansion”.

The problem of filter expansion when using byte-based pattern matching filters is illustrated as follows. To configure a filter that detects a multi-byte value, multiple pattern matchers can be required. For example, to identify the values 1-513, three filters could be configured as follows:

| Pattern | Byte 1 values | Byte 2 values | |
|---|---|---|---|
| matcher # | (most significant) | (least significant) | Matches values |
| 1 | 0 | 1-255 | 1-255 |
| 2 | 1 | 0-255 | 256-511 |
| 3 | 2 | 0-1 | 512-513 |

This pattern “expansion” can increase usage of filter resources, especially when additional data pattern filtering is required.

Current hardware filtering methods do not address these problems. What is needed is a system that can streamline the filtering process. Such a system could eliminate pattern “expansion” by pre-grouping and tagging incoming packets according to pre-determined criteria, and by compressing sets of multi-byte values into a single byte tag, which reduces pattern-based filter utilization. For example, packets arriving as part of many different streams but having the same protocol could be grouped, or tagged, and then filtered and sorted. There is a further need for a system in which tag values can be used by software applications (or hardware) as a means of pre-classifying the incoming packet information. Still further, there is a need for a system in which pattern-based filters can be used after tagging to provide filtering based on the tag value as well as other data within the packets. Even still further, a system is needed that automates filter setup.

### SUMMARY OF THE INVENTION

The problems set forth above as well as further and other problems are resolved by the present invention. The solutions and advantages of the present invention are achieved by the illustrative embodiments and methods described herein below.

The system and method of the present invention analyze incoming traffic from a computer network, such as, for example, but not limited to, a Wide Area Network (WAN), an Ethernet-based network, or an Asynchronous Transfer Mode (ATM) network. The system and method can identify and tag data prior to filtering according to identifying information contained in the data. Such identifying information can include stream identification, for example. A look-up table implemented, for example, in a Content Addressable Memory (CAM), can be used to map tags to the identifying information, and to provide the tag based on the presence of the identifying information in the data. A CAM can typically address thousands of entries and map those entries to a small set of tag values. For example, a CAM can be used to map ranges of VPI and VCI values (identifying information) into a small set of tags. This can greatly reduce the number of pattern-based filters required.

The method of the present invention can include, but is not limited to, the steps of associating a tag with at least one data type, mapping the tag to at least one data identifier, receiving the data having a cell data identifier from the electronic interface, assigning the tag to the data if the cell data identifier matches the at least one data identifier, and filtering the data based on the tag. The method can optionally include the steps of accessing a filter, assembling the data into at least one frame, storing the tag associated with the data in the at least one frame, sorting the at least one frame based on the filter to produce at least one filtered frame, and providing a report associated with the at least one filtered frame. The method can still further optionally include the steps of forming a look-up table from the step of associating the tag with the data type, storing the look-up table in a content addressable memory (CAM), and accessing the CAM to test for a match between the cell data identifier and the at least one data identifier.

For a better understanding of the present invention, reference is made to the accompanying drawings and detailed description. The scope of the present invention is pointed out in the appended claims.

### DESCRIPTION OF THE SEVERAL VIEWS OF THE DRAWING

FIG. 1 is a schematic block diagram of the environment in which the network traffic filtering system of the present invention executes;

FIG. 2 is a schematic block diagram depicting the relationship between virtual circuit links, virtual path links, and virtual channel connection in the context of the environment of the system of the present invention;

FIG. 3 is a schematic block diagram illustrating an exemplary ATM cell;

FIG. 4 is a schematic block diagram of the network traffic filtering system of the present invention; and

FIG. 5 is a flowchart of the method of the present invention.

### DETAILED DESCRIPTION OF THE INVENTION

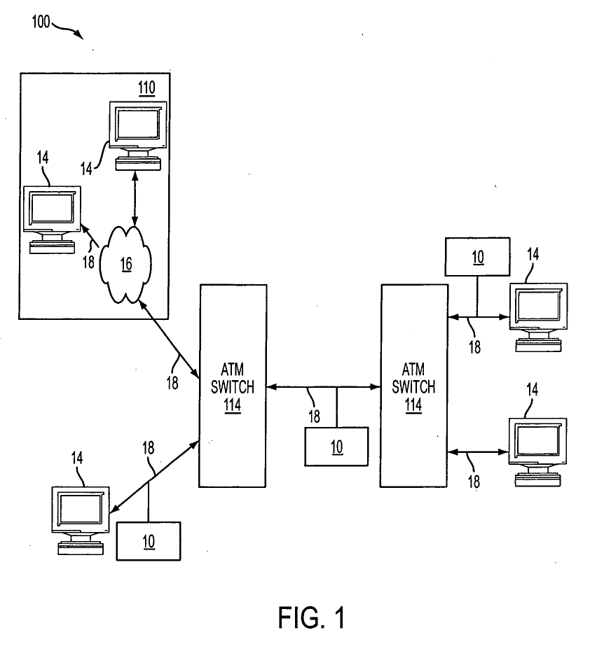

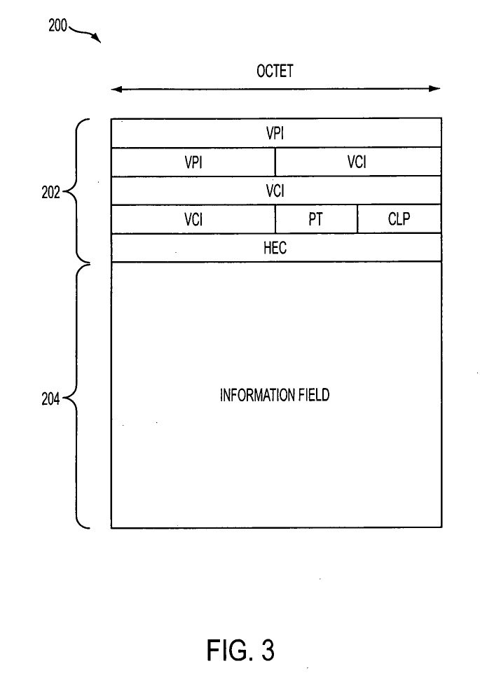

The present invention is now described more fully hereinafter with reference to the accompanying views of the drawing, in which the illustrative embodiments of the present invention are shown. To describe an example of use of system 10 of the present invention, information about an ATM network is provided in FIGS. 1-3. ATM is a packet-based communication protocol that communicates by transmitting and receiving fixed-size 53-byte packets, referred to as ATM cells 200 (FIG. 3). The example of an ATM network is used to illustrate the features of the present invention, but the present invention is not limited to use in the context of an ATM network. In particular, the invention could be practiced in the context of any electronically-connected communications network such as, for example, but not limited to, a WAN, an Ethernet-based network, or an ATM network.

Referring now to FIG. 1, ATM network 100 can include ATM switches 114 coupled together through electronic interface 18. ATM switches 114 route ATM traffic over electronic interface 18 according to the ATM communication standard (see www.atmforum.com). In an ATM network, electronic interface 18 can be referred to as, for example, network node interface (NNI) or user network interface (UNI), depending on whether electronic interface 18 connects communications network 16 or user devices such as computer node 14. Examples of UNIs include digital subscriber line (DSL), coaxial connection for a cable modem, T1 communication channel, optical, or wireless connection. In accordance with an embodiment of the system of the present invention, system 10 can be implemented between ATM switches 114, or between ATM switch 114 and, for example, computer node 14. System 10 can monitor any electronic interface 18 over which network data traverse, for example, ATM cells. As known to those skilled in the art, the various UNIs and NNIs can be carried by different physical media, such as those complying with plesiochronous digital hierarchy (PDH) or synchronous digital hierarchy (SDH) standards. Several different standards exist that define the manner in which the physical layer interface of an ATM communication network is performed. Numerous media, physical layers, protocols and services may co-exist within the same infrastructure to transport ATM cells, and all are included in this description. This implies that there are connection oriented and connection-less types of data that co-exist in parallel. ATM is designed to support all of these data types.

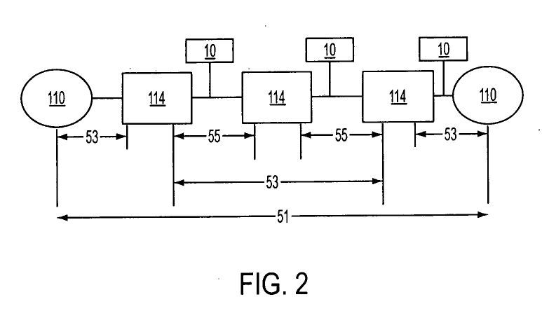

Referring now to FIG. 2, an ATM network 100 also makes use of what are referred to as “virtual circuits” to transport information. A virtual circuit (VC) link 53 is defined using what is referred to as a “virtual channel connection” (VCC) 51. VCC 51 is established between any source and any destination in an ATM network 100, regardless of the way that data are routed across the network. For example, computer nodes 14 and communications network 16 that form customer premises equipment 110 (FIGS. 1 and 2) can be considered “endpoints,” any of which can be a source or a destination of data in the form of ATM traffic. Fundamentally, ATM is a connection-oriented technology. A connection is established by transmitting a setup request, which traverses the network from the source to the destination endpoint. If the destination endpoint agrees to form a connection, a VCC 51 is established between the two endpoints. A mapping is defined between the virtual channel identifiers (VCI)/virtual path identifiers (VPI) of both UNIs associated with the source and destination endpoints, and between the appropriate input link and the corresponding output link of any intermediate switches resulting from a VC switch.

Continuing to refer to FIG. 2, VCC 51 may include a concatenation of several ATM VC links 53. All communication within the ATM network proceeds along the same VCC 51, which preserves cell sequence and provides a certain quality of service. The VCI in the ATM cell header (to be described below) is assigned per network entity-to-entity link, i.e., it may change across the network within the same VCC 51. A virtual path (VP) groups multiple VC links 53 carried between two ATM entities and may also involve many VP links 55. The VC links 53 associated with a VP are globally switched without unbundling or processing the individual VC or changing its VCI. Thus, the cell sequence of each VC is preserved and the quality of service of the VP depends on that of its most demanding VC. As the cell address mechanism uses both the VCI and the virtual path identifier (VPI), different VPs may also use the same VCI without conflict.

Referring now to FIG. 3, ATM cell 200 includes a five byte header portion 202 and a 48-byte payload portion 204. Header portion 202 contains information that defines the type of ATM cell 200 and the payload portion 204. Header 202 includes a VPI in the case of an NNI connection, or generic flow control (GFC) plus VPI in the case of a UNI connection. Header 202 also includes a VCI, a payload type (PT) indicator, a cell loss priority (CLP) bit, and a header error correction (HEC) byte. With regard to ATM cell 200, a byte is also referred to as an “octet.” Payload portion 204 is also referred to as the information field. ATM network 100 (FIGS. 1 and 2) directs traffic using identifiers VPIs and VCIs contained in header portion 202. VPI is the more local portion of the identifier of the VC number in an ATM header, and VCI is the more global portion of the identifier. ATM switches 114 (FIGS. 1 and 2) use the VPI/VCI fields to identify the next VC link 53 (FIG. 2) that ATM cell 200 needs to transit on its way to its final destination.

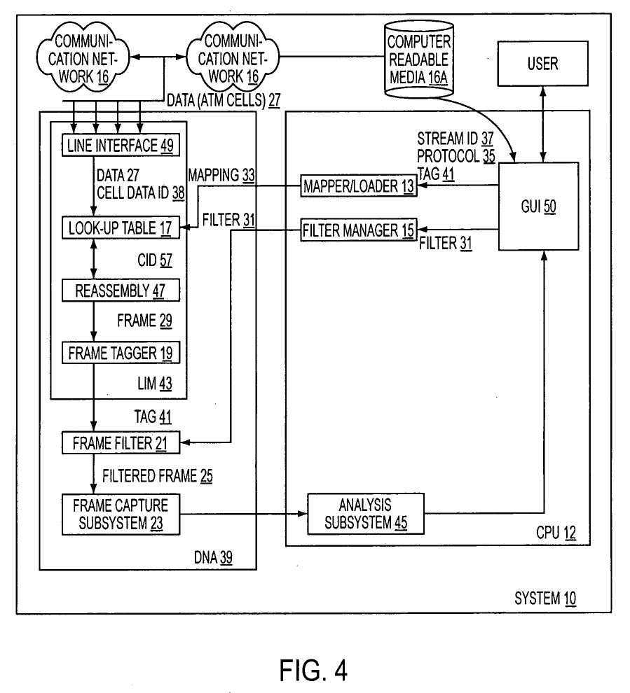

Referring now to FIG. 4, system 10 can include, but is not limited to, mapper/loader 13, filter manager 15, frame tagger 19, look-up table 17, frame filter 21, frame capture subsystem 23, reassembly 47, line interface 49, Graphical User Interface (GUI) 50, and analysis subsystem 45. System 10 can be implemented, in whole or in part, in hardware modules such as, for example, a conventional Line Interface Module (LIM) 43, for example Agilent Technologies® J6810A, and a conventional Distributed Network Analyzer (DNA) 39, for example Agilent Technologies® J6801A, or can be implemented in software, or a combination of hardware and software. Analog and digital LIMs 43 can receive physical line signals and output digital traffic to, for example, DNA 39. In the illustrative embodiment, for example, frame filter 21 is implemented in a field programmable gate array (FPGA) within DNA 39, and frame capture subsystem 23 contains a capture buffer that is implemented in Random Access Memory (RAM) and accessed by analysis subsystem 45, which can provide statistical analysis information about filtered frame 25 to a user.

Continuing to refer to FIG. 4, reassembly 47 can perform reassembly of ATM cells into frame 29 using, but not limited to, the ATM adaptation Layer (AAL) protocol at layers 2 (AAL-2) and 5 (AAL-5). Reassembly at AAL-2 can yield channel identifier (CID) 57 that can be fed back to look-up table 17 and can be used, along with stream identifier 37, port number, tributary number, VPI, and VCI to providing mapping 33. Look-up table 17 and reassembly 47 can be combined without altering the scope of the present invention.

Continuing to refer to FIG. 4, operationally, the user can, for example, provide protocol 35, tag 41 and stream identifiers 37. For example:

| Protocol/Tag | | | | |
|---|---|---|---|---|
| Value | VPI | VCI | Port # | Tributary |
| A/1 | 10-20 | 100-110 | 1 | 1 |
| A/1 | 20-30 | 100-110 | 2 | Any |
| B/2 | 10-20 | 200-205 | 1 | 2 |
| C/3 | 40-50 | 100-120 | 3 | Any |

Mapper/loader 13 can provide mapping 33 of provided and known information (VPI/VCI/Port number/Tributary to Protocol/Tag values) to tags 41 to form look-up table 17, which may be implemented using a CAM, a RAM, or a CAM and RAM combination. Filter manager 15 can allow filters 31 to be set up for further frame sorting. After the tags 41 and filters 31 are set up, data 27 that are received from ports 1-n are processed by look-up table 17, reassembly 47, tagger 19, and filters 31. Ports 1-n may be full duplex, receiving traffic from both sides of a full duplex link. Incoming data 27 can be tagged with the port number and line side from which it was received. Data 27 may also be received on a tributary, also referred to as a sub-channel, that is one of many data streams multiplexed within a larger “pipe” of data. For example, data 27 may be received on multiple E1 channels within an OC-3/STM communications controller. In this case, a tributary identification can be tagged in data 27 to identify which E1 sub-channel received data 27. For all incoming data 27, line interface 49 reads information such as the VPI, VCI, Port number and tributary for cell data identification 38. Subsequently, lookup table 17 indexes into the previously-defined table according to information supplied by line interface 49, and look-up table 17 supplies tag 41 associated with data 27. Reassembly 47 creates frames 29 from incoming data 27, and frame tagger 19 writes tags 41 into frame 29 header or trailer. Frame filter 21 examines tags 41 and other data within frame 29 with respect to filters 31 to make decisions regarding frame 29, including whether or not to store or discard frame 29. Furthermore, frame filter 21 may be configured to halt the acquisition of data 27. When filtering is successful, frame capture subsystem 23 can store filtered frame 25 in a capture buffer, for example in RAM, for access by analysis subsystem 45. Analysis subsystem 45 can access filtered frame 25 and use tag 41 to classify each filtered frame 25 without having to interrogate the contents of frame 29.

Continuing to refer to FIG. 4, frame filters 21 can, for example, compare relevant parts of frame 29 with tag 41 and, optionally, additional byte values. For example, with respect to the table above, frame filter 21 could be set up to store frames 29 according to filter 31 where the tag 41 in the frame header is 1 and the message type in the frame data is, for example, 5 (corresponding to protocol A). This action could, for example, enable frame filter 21 to compare one-byte values to one another where the frame data are located at fixed positions within frame 29. Other more variable comparisons are possible as well.

Continuing to still further refer to FIG. 4, and with reference to the implementation of look-up table 17, a CAM can receive data and emit an address, or an index. This address or index can be used to access, for example, RAM, which can emit information about data 27 including tag 41. In the present invention, a CAM emits an index whenever cell data identification 38 is loaded. If cell data identification 38 is not present in the CAM then cell data identification 38 can be added to the CAM and an index can be emitted. Other data with the same identification as cell data identification 38 can be, from then on, identified with the same index.

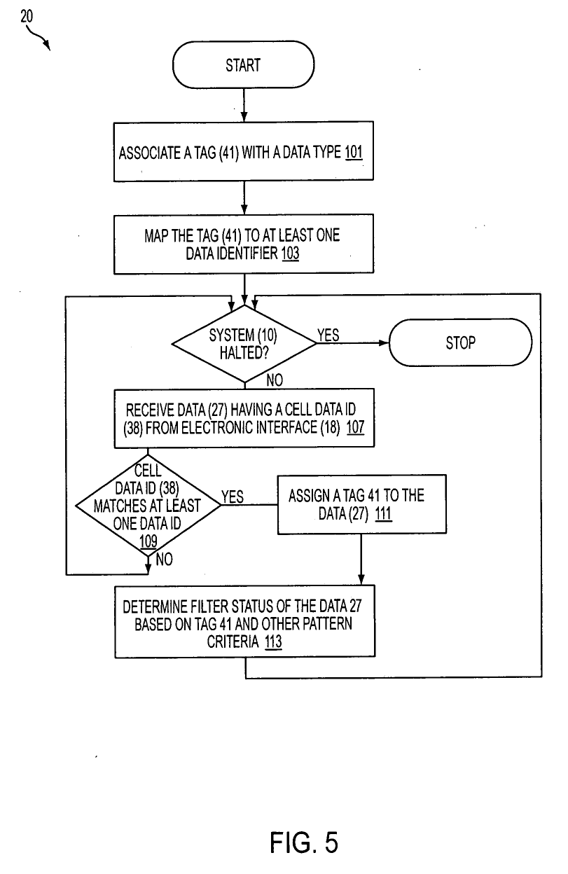

Referring now primarily to FIG. 5, method 20 of the present invention can include, but is not limited to, the steps of associating a tag 41 (FIG. 4) with at least one data type (method step 101) and mapping the tag 41 (FIG. 4) to at least one data identifier (method step 103). If system 10 (FIG. 4) is not halted (decision step 106), method 20 can further include the step of receiving data 27 (FIG. 4) having a cell data identifier 38 (FIG. 4) from electronic interface 18 (FIG. 4) (method step 107). If cell data identifier 38 matches at least one data identifier (decision step 109), method 20 can further include the steps of assigning tag 41 to data 27 (method step 111) and determining a status of data 27 as a result of filtering data 27 based on tag 41 (method step 113). If cell data identifier 38 does not match at least one data identifier (decision step 109), method 20 can continue receiving data 27 (method step 107) if system 10 is not halted (decision step 106). Method 20 can optionally include the steps of accessing a filter 31 (FIG. 4), assembling data 27 into at least one frame 29 (FIG. 4), storing tag 41 associated with data 27 in at least one frame 29, storing at least one frame 29 based on the processing of filter 31 performed by frame filter 21 to produce at least one filtered frame 25 (FIG. 4), and providing a report associated with at least one filtered frame 25. Method 20 can further optionally include the steps of forming a look-up table 17 (FIG. 4) from the step of associating the tag 41 with the data type, storing look-up table 17 in a CAM, and accessing the CAM to test for a match between cell data identifier 38 and at least one data identifier.

Method 20 (FIG. 5) can be, in whole or in part, implemented electronically. Signals representing actions taken by elements of system 10 (FIG. 4) can be electronically executed and stored on at least one computer-readable medium 16A (FIG. 4). Common forms of at least one computer-readable medium 16A can include, for example, but are not limited to, a floppy disk, a flexible disk, a hard disk, magnetic tape, or any other magnetic medium, a CDROM or any other optical medium, punched cards, paper tape, or any other physical medium with patterns of holes, a RAM, a Programmable Read Only Memory (PROM), and Erasable PROM (EPROM), a FLASH-EPROM, or any other memory chip or cartridge, a carrier wave, or any other medium from which a computer can read. System 10 if the present invention can be implemented in software (e.g., firmware), hardware, or a combination thereof. Regardless of the manner of implementation, the software portion of system 10 can be executed by a special or general-purpose computer, such as a personal computer (PC; IBM-compatible, Apple-compatible, or otherwise), workstation, minicomputer, or mainframe computer. Furthermore, system 10 may be implemented in other processing or computing devices, such as, for example but not limited to, a dedicated processor.

Although the invention has been described with respect to various embodiments and methods, it should be realized that this invention is also capable of a wide variety of further and other embodiments and methods within the spirit and scope of the appended claims.

What is claimed is:

1. A method for filtering data from an electronic interface comprising the steps of:
associating a tag with at least one data type;
mapping the tag to at least one data identifier;
receiving the data having a cell data identifier from the electronic interface;
assigning the tag to the data if the cell data identifier matches the at least one data identifier; and
filtering the data based on the tag.

2. The method as defined in claim 1 wherein the data type is a data communications protocol type.

3. The method as defined in claim 1 wherein the at least one data identifier is a stream identification.

4. The method as defined in claim 1 wherein the at least one data identifier is a virtual channel identifier (VCI).

5. The method as defined in claim 1 wherein the at least one data identifier is an Asynchronous Transfer Method (ATM) Adaptation Layer 2 (AAL-2) channel identifier.

6. The method as defined in claim 1 wherein the at least one data identifier is a virtual path identifier (VPI).

7. The method as defined in claim 1 further comprising the steps of:
accessing a filter;
assembling the data into at least one frame;
storing the tag associated with the data in the at least one frame;
sorting the at least one frame based on the filter to produce at least one filtered frame; and
providing a report associated with the at least one filtered frame.

8. The method as defined in claim 1 further comprising the steps of:
forming a look-up table from said step of associating the tag with the data type;
storing the look-up table in a content addressable memory (CAM); and
accessing the CAM to test for a match between the cell data identifier and the at least one data identifier.

9. The method as defined in claim 1 wherein the data are transmitted across an electronic interface providing an electronic connection between an Asynchronous Transfer Mode (ATM) switch and a computer node.

10. The method as defined in claim 1 wherein the data are transmitted across an electronic interface providing an electronic connection between a first ATM switch and a second ATM switch.

11. A system for filtering data from an electronic interface comprising:
a look-up table capable of storing at least one data type associated with at least one data identifier, said look-up table capable of determining if a cell data identifier matches said at least one data identifier;
a mapper/loader capable of determining a mapping between a tag and said at least one data type, said mapper/loader being capable of loading said look-up table with said mapping; and
a line interface capable of receiving the data from the electronic interface, said line interface capable of providing the data to said look-up table, wherein said look-up table is capable of assigning said tag to the data to prepare the data for filtering if said cell data identifier matches said at least one data identifier.

12. The system as defined in claim 11 further comprising:
a reassembly capable of forming the data into at least one frame;
a frame tagger capable of associating at least one said tag with said at least one frame;
a filter manager capable of determining a filter; and
a frame filter capable of applying said filter to said at least one frame, said frame filter capable of forming at least one filtered frame.

13. The system as defined in claim 11 further comprising:
an analysis subsystem capable of analyzing said at least one filtered frame.

14. The system as defined in claim 12 further comprising:
a frame capture subsystem capable of storing said at least one filtered frame; and
an analysis subsystem capable of accessing said at least one filtered frame from said frame capture subsystem, said analysis subsystem capable of analyzing said at least one filtered frame.

15. The system as defined in claim 12 further comprising:
a line interface module (LIM) capable of synchronizing the execution of said frame tagger, said reassembly, and said look-up table.

16. The system as defined in claim 15 further comprising:
a distributed network analyzer (DNA) capable of synchronizing the execution of said LIM and said frame filter.

17. The system as defined in claim 11 further comprising:
a reassembly capable of forming the data into at least one frame;
a frame tagger capable of associating at least one said tag with said at least one frame;
a filter manager capable of determining a filter;
a frame filter capable of applying said filter to said at least one frame, said frame filter capable of forming at least one filtered frame;
a LIM capable of synchronizing the execution of a frame tagger, said reassembly, and said look-up table;
a frame capture subsystem capable of storing said at least one filtered frame;
an analysis subsystem capable of accessing said at least one filtered frame from said frame capture subsystem, said analysis subsystem capable of analyzing said at least one filtered frame;
a CPU capable of synchronizing the execution of said mapper/loader, said filter manager, and said analysis subsystem;
a DNA capable of synchronizing the execution of said LIM and said frame filter; and
an Asynchronous Transfer Mode (ATM) switch capable of synchronizing the execution of said CPU, said DNA, said LIM, said frame capture subsystem, and said line interface.

18. A computer electronically connected to a communications network capable of carrying out the method according to claim 1.

19. A computer data signal embodied in electromagnetic signals traveling over a communications network carrying information capable of causing a computer electronically connected to the communications network to practice the method of claim 1.

20. A computer readable medium having instructions embodied therein for the practice of the method of claim 1.
